(19) United States
(12) Patent Application Publication
(10) Pub. No.: US 2015/0224514 A1
(43) Pub. Date: Aug. 13, 2015

(54) METAL SEPARATOR AND METHOD OF USE THEREOF

(71) Applicant: Daniel Mercado, Bloomingdale, GA (US)

(72) Inventor: Daniel Mercado, Bloomingdale, GA (US)

(21) Appl. No.: 14/176,751

(22) Filed: Feb. 10, 2014

(51) Int. Cl. B03B 5/62; B07B 7/02; B07B 9/02

(52) U.S. Cl. CPC B03B 5/623; B07B 9/02; B07B 7/02

(57) ABSTRACT

A metal separator device includes a chamber with a top end and a bottom end. The chamber has a constant size throughout its length from the bottom end to the top end. The top end includes a material inlet in communication with the interior of the chamber, and an exit adapted for allowing fluid and material to exit the top end. The exit is positioned above the material inlet. The bottom end includes a fluid inlet in communication with at least one vortex port in the chamber. Each of the at least one vortex ports is an angled opening in the bottom of the chamber adapted for creating a uniform vortex of fluid flowing upward in said chamber.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field

The disclosure generally relates to the mining arts, like the treatment of materials derived from a mining operation for the purpose of separating out the various components making up such material. More specifically, the disclosure relates to a metal separator and a method of using the same, for sorting metals, like gold and other like materials.

2. Description of Related Art

The disclosure is directed to a separator for separating metals, like gold in flake and small nugget form, from heavy sand and rock by fluidized bed techniques whereby the gold is gravitationally separated to the bottom of the column.

In the past, sand which carried metals therein, like gold, would be passed through a device for the separation of gold therefrom. These separators have usually been in the form of sluice boxes and the like which have separated from the lighter sand the larger gold nuggets. However, smaller bits of metal or gold, particularly flakes thereof, have not been separated and have been returned to the earth with the sand. As a result, stream beds and banks still can be mined for the smaller bits of metal or gold.

The current mining process may begin with the collection of heavy sand and rock materials. This heavy sand may contain gold flakes and other small gold particles so that another separation is necessary. Conventionally, the separation of the heavy sand away from the gold was by panning. In panning, extreme time, effort and concentration must be used if the majority of the gold is to be separated out and collected. Such careful panning is necessarily time consuming so that the final separation from the portion conserved by the separator is tedious. A reliable and quick method and apparatus for separating the heavy fraction provided is thus required.

As a result, gold mining of today may require a process of constant concentration levels. Taking each step in this process leaves unwanted impurities, or heavy materials, which further need to be removed. Many other steps must be taken to further concentrate the captured/retained heavy material. The ultimate goal is to continually concentrate the material until the desired metal, like gold, is in pure form. This separation to pure form is obviously desired to be done in as little steps and as quick as possible to reach the level of hyper-concentration, i.e. the level where gold, or the desired metal, is 95-99% free from other impurities. Currently there is no known device or separation process for hyper-concentration, which is controlled, quick and efficient.

Therefore, it is readily apparent that there is a recognizable unmet need for a metal separator that is easy to produce, efficient and controlled to reach hyper-concentration levels of separation.

### SUMMARY

Briefly described, in a preferred embodiment, the present apparatus and method overcomes the above-mentioned disadvantages and meets the recognized need for such a device by providing a metal separator capable of hyper-concentration in a controlled, quick and efficient process.

The present apparatus and method includes a metal separator having a chamber with a top end and a bottom end. The chamber has a constant size throughout its length from the bottom end to the top end. The top end includes a material inlet in communication with the interior of the chamber, and an exit adapted for allowing fluid and material to exit the top end. The exit is positioned above the material inlet. The bottom end includes a fluid inlet in communication with at least one vortex port in the chamber. Each of the at least one vortex ports is an angled opening in the bottom of the chamber adapted for creating a uniform vortex of fluid flowing upward in the chamber. Whereby, when material is introduced into the material inlet thus creating a bed of material in the chamber, fluid can be pumped into the fluid inlet through the bottom of the chamber including each of the vortex ports for creating a uniform vortex of fluid flowing from the bottom end of the chamber up the interior of the chamber and out of the exit thereby fluidizing the bed. This uniform fluidized bed may move the materials with a higher specific gravity to the bottom of the chamber and materials with a lower specific gravity to the top of the chamber and out of the exit.

One feature of the instant disclosure may be the uniform flow of fluid through the metal separator device, i.e. the fluid flows at a constant speed through the chamber.

Another feature of the instant disclosure may be the uniform size of the chamber throughout its length.

Another feature of the instant disclosure may be the vortex ports which may be angled holes around the bottom of the chamber adapted for creating a uniform vortex of fluid flowing upward in the chamber.

Another feature may be the bottom cap that can be included in select embodiments for sealing the bottom end of the chamber. The bottom cap may house the inlet and provide a cavity between the inlet and the bottom of the chamber including the vortex ports.

Another feature may be the flow disturbance device or devices positioned on the interior of the chamber that can be included in select embodiments.

Another feature may be the ability for the material inlet to be selectively sized to allow material up to a selected inlet size into the interior of the chamber.

Another feature may be that the material inlet may introduce material directly into the vortex of fluid.

Another feature may be the ability for the exit to be selectively sized to allow material up to a selected size to exit the chamber.

In use, a method of separating metals may be conducted utilizing various embodiments of the metal separator device shown and described herein. The method of separating metals may include the steps of: providing the metal separator device; inserting material into the material inlet thereby creating a bed of material in the interior of the chamber; pumping a fluid into the fluid inlet through each of the vortex ports into the inside of the chamber creating a uniform vortex of fluid flowing from the inlet up through the chamber and out of the exit thereby fluidizing the bed of material and moving the materials with a higher specific gravity to the bottom of the chamber and materials with a lower specific gravity to the top of the chamber and out of the exit.

Another feature may be the ability of the metal separator device to be linked together with one or more subsequent metal separator devices to create a system for metal separation.

The system for metal separation may include a plurality of metal separator devices, as shown and described in various embodiments herein, linked to one another where the first metal separator device separates a first sized material and each subsequent metal separator device separates smaller sized material.

One feature of the system may be that each of the metal separator devices may be in fluid communication with the material inlet of a subsequent metal separator device via a connector conduit. In select embodiments, each of the connector conduits may include a selectively sized grate for allowing material up to a certain size to move into the material inlet of a subsequent metal separator device. In other select embodiments, a withdrawal tube may be included for moving material too large to pass through the selectively sized grate out of the system. The withdrawal tubes may be linked together to subsequent withdrawal tubes.

In use, the system for metal separation may provide a method of separating metals, including the steps of: providing at least one subsequent metal separator device; connecting the exit of the metal separator device with the material inlet of the subsequent metal separator device via a connector conduit; providing a selectively sized grate in the connector conduit between the exit and the material inlet; moving material smaller than the selectively sized grate into the chamber of the subsequent metal separator device; and removing material larger than the selectively sized grate via a withdrawal tube.

Another feature of the metal separator may be its ease of use and thus ability to be used by different people with various metal separation experience.

Yet another feature of the metal separator device may be its ability to function for extended periods of time.

Yet another feature of the metal separator device may be its ability to be easy to manufacture.

These and other features of the metal separator and its method of use thereof will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present metal separator device will be better understood by reading the Detailed Description with reference to the accompanying drawings, which are not necessarily drawn to scale, and in which like reference numerals denote similar structure and refer to like elements throughout, and in which:

FIG. 1 is a perspective view of an exemplary embodiment of the metal separator device;

FIG. 2 is a cross-sectional view of the embodiment of FIG. 1;

FIG. 3 is a cross-sectional view of one embodiment of the bottom of the chamber through the vortex ports.

FIG. 4 is a perspective exploded view of the embodiment of FIG. 1;

FIG. 5 is a cross-sectional view of the embodiment of FIG. 1, shown in use with an illustrative diagram of the uniform fluidized bed of material;

FIG. 6 is a perspective view of an exemplary embodiment of the system of metal separators;

FIG. 7 is a partial cross-sectional view of the embodiment from FIG. 5; and

FIG. 8 is a flow chart depicting an exemplary use of an embodiment.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

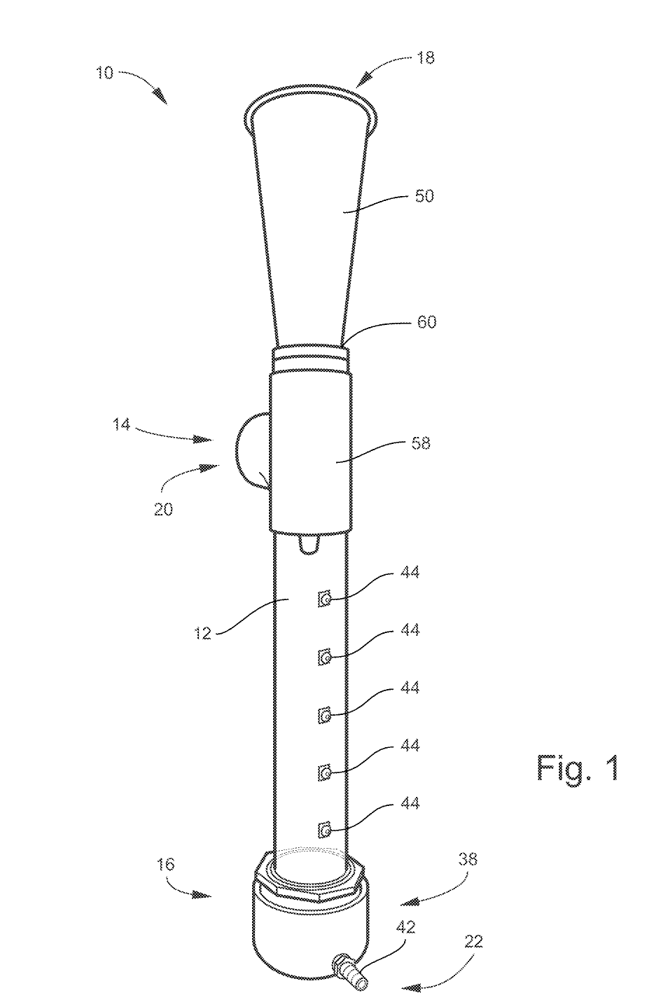

In describing the exemplary embodiments of the present disclosure, as illustrated in FIGS. 1-8, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1-5 by way of example, and not limitation, therein is illustrated example embodiments of metal separator 10. As shown therein, metal separator 10 generally comprises chamber 12 with top end 14 and bottom end 16. The chamber 12 has a constant size throughout its length from bottom end 16 to top end 14. Top end 14 may include material inlet 18 and exit 20. Material inlet 18 may be in communication with the interior of chamber 12. Exit 20 may be for allowing fluid and material to exit top end 14 of chamber 12. Exit 20 may be positioned above material inlet 18. Bottom end 16 may include fluid inlet in communication with at least one vortex port 24 in chamber 12, where each of the at least one vortex ports 24 may be an angled opening in the bottom of chamber 12 adapted for creating uniform vortex of fluid 30 flowing upward in chamber 12.

One feature of the instant disclosure may be the uniform flow of fluid 26 created through chamber 12 of metal separator device 10 from its bottom end 16 to its top end 14. A uniform flow of fluid, as used and described herein, may refer to a constant speed or flow of fluid throughout the device. This uniform flow of fluid 26 may be created by chamber 12 having a constant size from its bottom end 16 to its top end 14. Although chamber 12 may ideally have a cylindrical shape or a round cross-section with a constant diameter, as shown in the Figures, the invention is not so limited. Chamber 12 may have any various other desired cross-sections with a constant size or diameter from its bottom end 16 to its top end 14, including, but not limited to, an oval cross-section, a square cross-section, a hexagon cross-section, an octagon cross-section, or any other desired cross-section.

Vortex ports 24 may be cut into the bottom of chamber 12. Vortex ports 24 may be for creating uniform vortex flow of fluid 30 inside chamber 12 from its bottom end 16 to its top end 14. Fluid 26 may enter the chamber through multiple ports located at the lowest point possible. This may be critical to create uniform rotation of vortex of fluid 30 within chamber 12. The rotation created by vortex ports 24 may ensure a uniform speed of raising fluid. This raising column may be what separates the densities of material 28.

Fluid 26 used in the process of metal separator device 10 may be any desired fluid, including, but not limited to, water or other desired liquids, or air or other desired gases. In select embodiments, like for gold and gold flake separation, fluid 26 may be water. A pump or other similar device or water supplies may be used to move fluid 26 into metal separator device 10 at various desired speeds to create the desired uniform flow of fluid 26 within chamber 12.

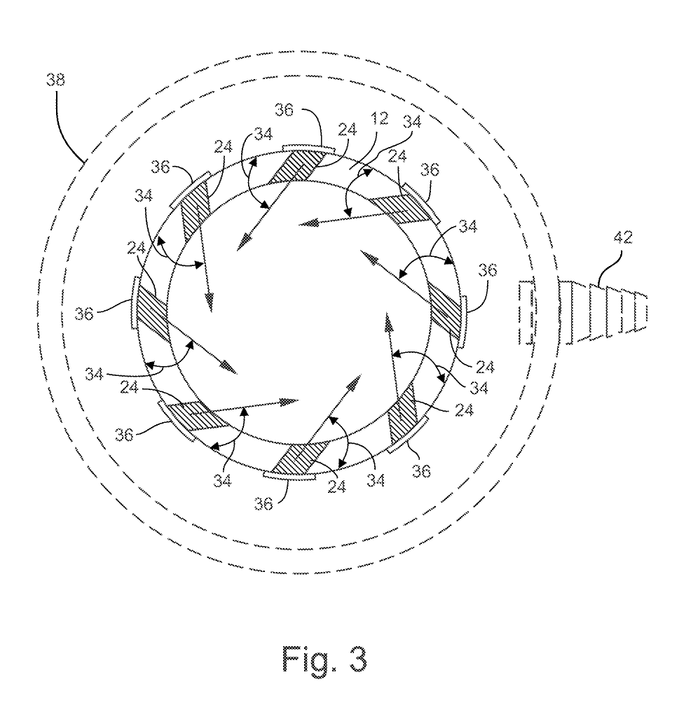

In one embodiment, vortex ports 24 may be angled holes around the bottom of chamber 12 adapted for creating uniform vortex of fluid 30 flowing upward in chamber 12. Any number of vortex ports 24 may be included in the bottom of chamber 12 and may be oriented in various positioning and spacing to create the desired vortex of fluid 30. In select embodiments, vortex ports 24 may be equally spaced around the bottom of chamber 12. In one embodiment, as shown in FIG. 3, eight vortex ports 24 may be included in bottom end 16 of chamber 12.

Referring again to FIG. 3, in select embodiments, vortex ports 24 may be cut into chamber 12 at angle 34. Angle 34 may be any desired angle for creating uniform vortex of fluid 30 flowing upward in chamber 12. In one embodiment, angle 34 of vortex ports 24 may be between 10 and 80 degrees to its tangent. In another embodiment, as shown in FIG. 3, the angle 34 of vortex ports 24 may be 45 degrees to its tangent, or approximately 45 degrees to its tangent.

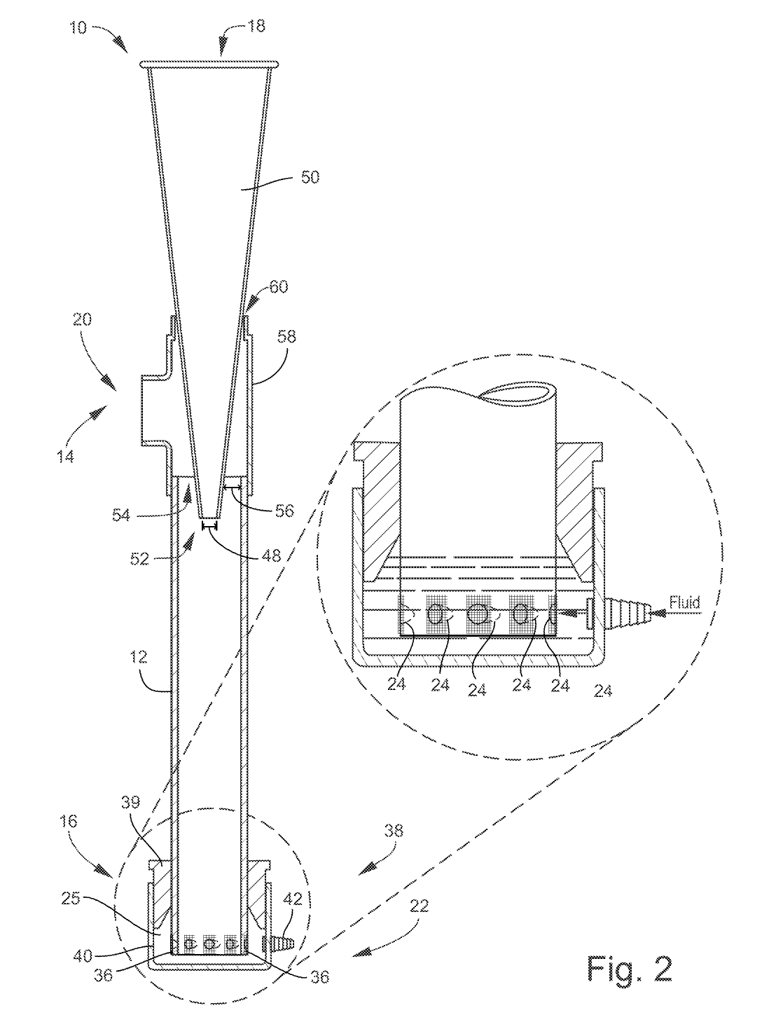

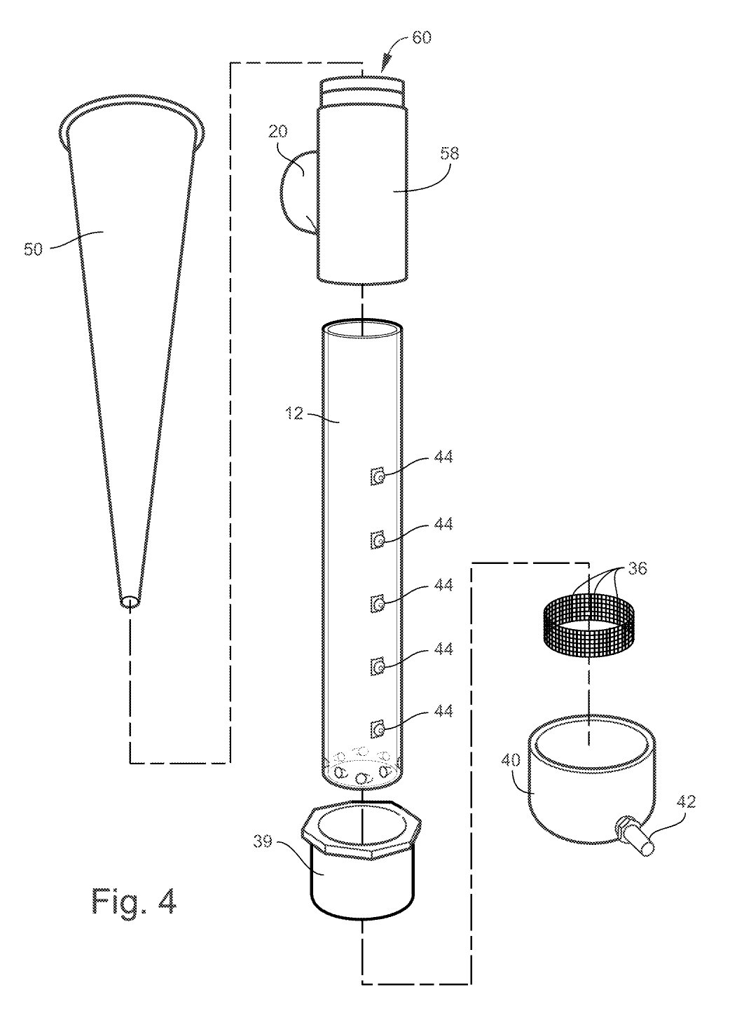

Screen 36 or plurality of screens 36 may be included on or inside chamber 12 for covering vortex ports 24. Screen 36 or plurality of screens 36 may be adapted to prevent any material from exiting vortex ports 24, while still allowing fluid to flow through vortex ports 24. In one embodiment, as shown in FIGS. 2, 3 and 5, a plurality of small screens 36 may be used to cover each individual vortex port 24. In this embodiment, each of the plurality of screens 36 may be secured to each of vortex ports 24, like by welding, adhesives, slots, grooves, the like, etc. In another embodiment, as shown in FIG. 4, a single screen may be utilized that wraps around chamber 12 for covering vortex ports 24. In this embodiment, screen 36 may be secured on chamber 12, like by welding, adhesives, the like, slots, grooves, etc., and/or screen 36 may be sized to wrap tightly around chamber 12 thereby holding it in place.

Bottom cap 38 may be included in select embodiments for sealing bottom end 16 of chamber 12. Bottom cap 38 may house fluid inlet 22 and provide cavity 25 between fluid inlet 22 and the openings in the bottom of chamber 12 including vortex ports 24. Cavity 25 may be included to provide a uniform flow of fluid 26 into the bottom of chamber 12. In select embodiments, bottom cap 38 may include top section 39 and bottom section 40. The top section 39 of bottom cap 38 may be sealed to chamber 12 above vortex ports 24, and bottom section 340 may include an inlet port 42 for introducing fluid and may be sealed to top section 39 thereby creating cavity 25 between top section 39 and bottom section 40.

Flow disturbance device 44 or a plurality of flow disturbance devices 44 may be included in select embodiments of metal separator device 10. Flow disturbance devices 44 may be provided in vortex of fluid 30 to ensure all material is exposed to the rotating column of water by separating the material and providing paths for higher specific gravity material to move down and for lower specific gravity material to move up. Flow disturbance devices 44 may be positioned on the interior of chamber 12, and can be various shapes, including, but not limited to, a cylindrical shape (as shown), a knob shape, a mound shape, a pyramidal shape, a triangular shape, a square shape, a hexagon shape, an octagon shape, the like, and/or combinations thereof. In select embodiments, each of flow disturbance devices 44 may be made from rubber and can be secured to the inside of chamber 12 by a securement means, like a screw. Flow disturbance devices 44 may be positioned anywhere on the interior of chamber 12. In select embodiments, flow disturbance devices 44 may be positioned in a linear row along the length of chamber 12 from its bottom end 16 to its top end 14. Flow disturbance devices 44 may be equally spaced along such linear row. In one embodiment, as shown in FIGS. 1 and 4, five flow disturbance devices 44 may be positioned in equal spaces in a linear row along the length of chamber 12 from its bottom end 16 to its top end 14.

As best shown in FIG. 2, another feature of metal separator device 10 may be the ability for material inlet 18 to be selectively sized to allow material up to selected inlet size 48 into the interior of chamber 12. Selected inlet size 48 may be any desired size and may vary depending on the type of metal being separated, the type of material mined for separation (heavy sand, light sand, etc.), and/or the number of metal separator devices 10 being used in the process. In select embodiments, material inlet 18 may include funnel 50 adapted for introducing material 28 into chamber 12. In one embodiment, funnel 50 may includes bottom opening 52 that can be sized to the desired selected inlet size 48.

Referring again to FIG. 2, another feature of metal separator 10 may be the ability for exit 20 to be selectively sized to allow material up to selected exit size 56 to exit chamber 12. Selected exit size 56 may be any desired size and may vary depending on the type of metal being separated, the type of material mined for separation (heavy sand, light sand, etc.), and/or the number of metal separator devices 10 being used in the process. In one embodiment, exit 20 may include channel 54 being selectively sized to allow material up to selected exit size 56 to exit chamber 12. Channel 54 may be created by bottom opening 52 of funnel 50 and the interior of chamber 12.

Sleeve 58 may be included in select embodiments on top end 14 of chamber 12, as best shown in FIG. 4. Sleeve 58 may be sealed to the top of chamber 12. Sleeve 58 may include exit 20 on its side and opening 60 at its top adapted to receive funnel 50. In select embodiments, sleeve 58 may be integral with chamber 12. In other embodiments, sleeve 58 may be a separate piece sealed to the top of chamber 12.

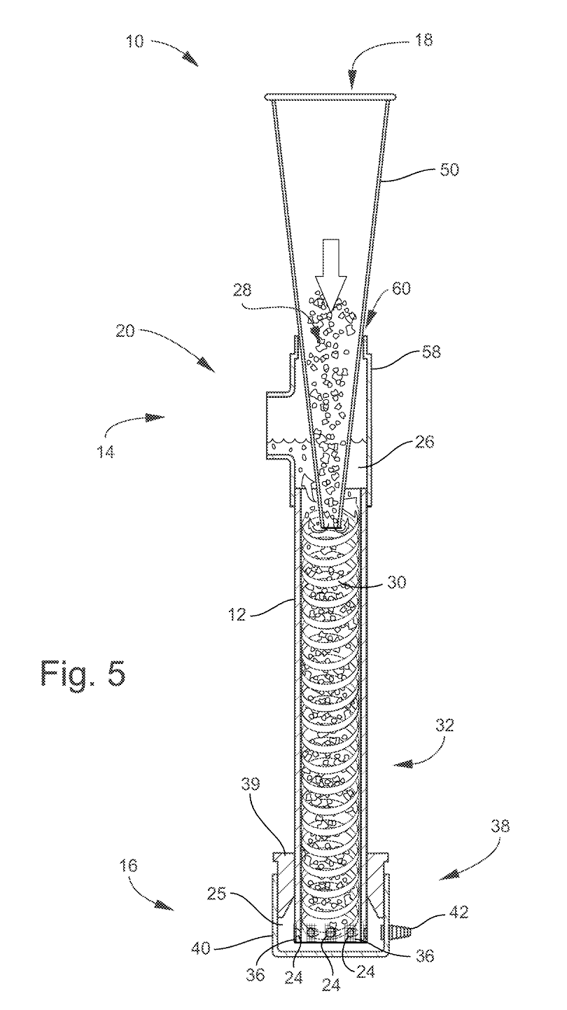

Referring to FIG. 5, when material 28 may be introduced into the interior of chamber 12 through material inlet 18 thus creating bed of material 32, fluid 26 being pumped into fluid inlet 22 through the bottom of chamber 12 and each of vortex ports 24 can create uniform vortex of fluid 30 flowing from bottom end 16 of chamber 12 up the interior of chamber 12 and out of exit 20 thereby fluidizing bed 32 and moving the materials with a higher specific gravity to bottom end 16 of chamber 12 and materials with a lower specific gravity to top end 14 of chamber 12 and out of exit 20.

Referring again to FIG. 5, material inlet 18 may be used to introduce material 28 directly into vortex of fluid 30. For example, as shown in FIG. 5, bottom opening 52 of funnel 50 may be positioned below exit 20 in sleeve 58. This embodiment may force all material 28 entering funnel to be submerged in vortex of fluid 30 upon entering chamber 12. This feature of metal separator device 10 may insure that all material is processed in a controlled and/or dependable fashion by forcing all material 28 introduced into chamber 12 to be submerged into vortex of fluid 30.

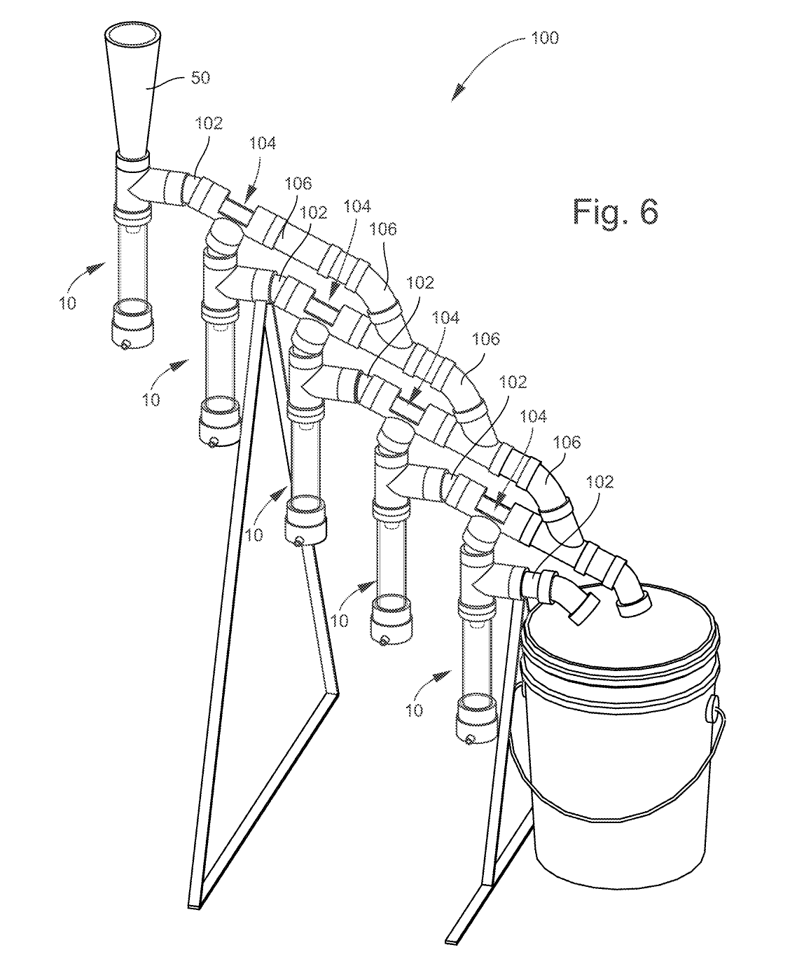

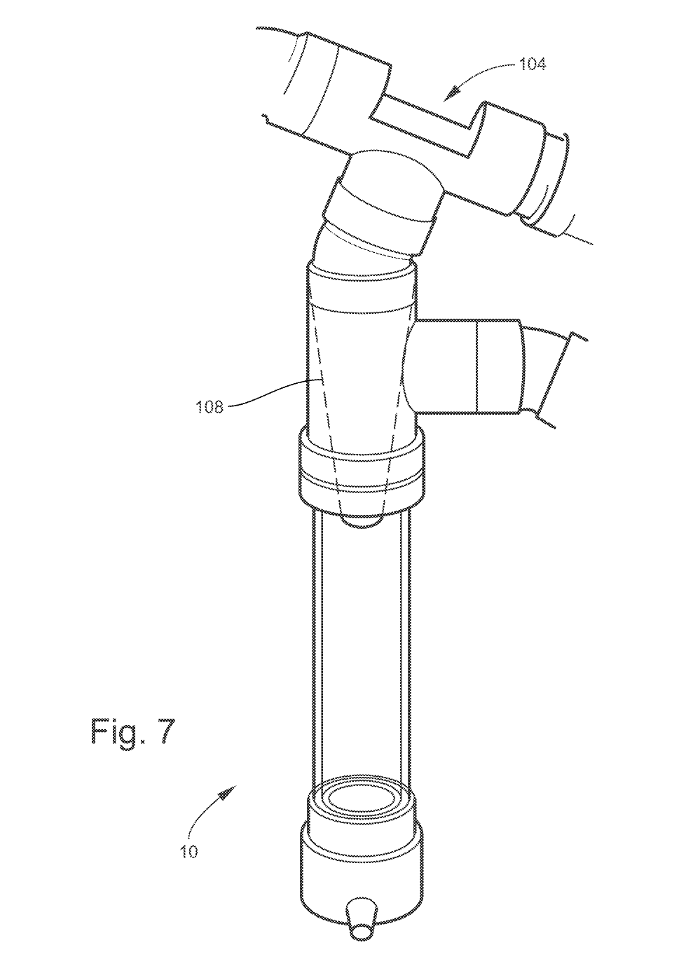

Referring now to FIGS. 6-7, system for metal separation 100 is shown. System 100 includes a plurality of metal separator devices 10, including any of the various embodiments shown and described herein. Metal separator devices 10 may be linked to one another where the first metal separator device 10 separates a first sized material and subsequent metal separator devices 10 separate smaller sized material. In one embodiment, exit 20 of each of metal separator devices 10 may be in fluid communication with material inlet 18 of a subsequent metal separator device 10 via connector conduit 102. In select embodiments, each of connector conduits 102 may include selectively sized grate 104 for allowing material up to a certain size to move into material inlet 18 of a subsequent metal separator device 10. As shown in FIG. 7, in select embodiments internal funnel 108 may be included in each of the connector conduits 102 between selectively sized grate 104 and the associated material inlet 18. Internal funnel 108 may function the same as funnel 50 described above but may be internal to each of the connector conduits 102. As shown in the Figures, connector conduits 102 may include an opening above selectively sized grates 104 and internal funnel 108 for inspection and service thereof. In yet other select embodiments, each of the connector conduits 102 may include withdrawal tube 106 for moving material to large to pass through selectively sized grate 104 out of system 100. As shown in FIG. 6, in some embodiments each of withdrawal tubes 106 may be linked together to subsequent withdrawal tubes 106.

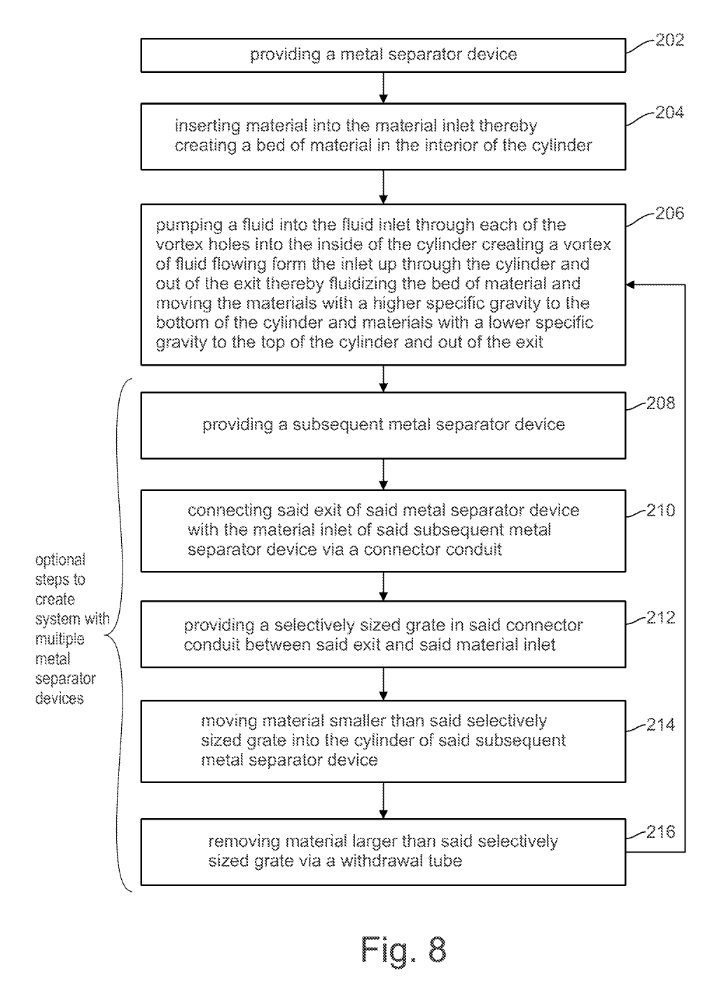

Referring now to FIG. 8, in use, method of separating metals 200 may be conducted utilizing various embodiments of the metal separator device 10 as shown and described herein. Method of separating metals 200 may generally include the steps of: step 202 of providing the metal separator device; step 204 of inserting material into the material inlet thereby creating a bed of material in the interior of the chamber; and step 206 of pumping a fluid into the fluid inlet through each of the vortex ports into the inside of the chamber creating a uniform vortex of fluid flowing from the inlet up through the chamber and out of the exit thereby fluidizing the bed of material and moving the materials with a higher specific gravity to the bottom of the chamber and materials with a lower specific gravity to the top of the chamber and out of the exit.

As shown in FIG. 8, in select optional embodiments, method of separating metals 200 may include at least one subsequent separator device 10 as with system 100 described above and shown in FIGS. 6-7. In these optional embodiments of method of separating metals 200, the process may further comprise the following steps: step 208 of providing at least one subsequent metal separator device; step 210 of connecting said exit of said metal separator device with the material inlet of said subsequent metal separator device via a connector conduit; step 212 of providing a selectively sized grate in said connector conduit between said exit and said material inlet; step 214 of moving material smaller than said selectively sized grate into the chamber of said subsequent metal separator device; and step 216 of removing material larger than said selectively sized grate via a withdrawal tube. Steps 208-216 may be repeated as many times as desired for each subsequent metal separator device 10 added in the process.

With the various embodiments of metal separator device 10, system of metal separation 100 and method of metal separation 200, alone or in combination, gold and other metals may be separated in a process of constant concentration levels. Taking each step in this process leaves unwanted impurities, heavy materials, which further need to be removed. Each of the separation steps in metal separator device 10 and subsequent metal separator devices may be taken to further concentrate the captured/retained heavy material. The ultimate goal may be to continually concentrate the material until the desired metal is in pure form. Metal separator device 10, system of metal separation 100 and method of metal separation 200, alone or in combination, may greatly reduce the number of steps needed, and time, to reach the level of hyper-concentration

In general, the various embodiments of metal separator device 10, system of metal separation 100 and method of metal separation 200, alone or in combination, can reduce raw material to the desired material with no moving parts and only using water or other desired fluids. Due to the simple design shown and described herein it may be very inexpensive relative to common mineral mining/refining equipment. In addition, the various embodiments of metal separator device 10, system of metal separation 100 and method of metal separation 200, alone or in combination can be easily scaled.

The various embodiments of metal separator device 10, system of metal separation 100 and method of metal separation 200, alone or in combination, as shown herein are directed toward metal separation, and more particularly to the separation of gold and gold flakes. However, the invention is not so limited and may be used for the separation of any material that needs to be separated into densities by a fluidized bed of material. This may include any other area other than separating metals and gems from other materials where the instant disclosure's method and construction can replace all fluidbed mixing and separating devices. As merely examples, and clearly not limited thereto, metal separator device 10, system of metal separation 100 and method of metal separation 200, alone or in combination, could be used in other industries that can benefit from a fluidized bed device, including: agriculture, like separating foreign objects from seeds, corn, and grains to ensure only desired particles; lumber, like removing metal objects from saw dust and other lumber products; powder bulk, like removing unwanted dense particles from bulk powder/granular products like flour or sugar; recycling, like separating metal shavings of different metals without the melting process; the food industry, like pop-corn kernels that need to be cleaned and sorted by density (the instant disclosure could be tuned to separate kernels faster and cheaper with less moving parts then possibly any other product on the market); coffee, like density separating of coffee beans; and any other industry requiring separation of materials or particles by density.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A metal separator device, wherein said metal separator device comprises:
a chamber with a top end and a bottom end and a constant size throughout its length from said bottom end to said top end;
said top end includes:
a material inlet in communication with the interior of said chamber;
an exit to allow fluid and material to exit the top end of said chamber; and
said exit is positioned above said material inlet; and
said bottom end includes:
a fluid inlet in communication with the bottom of said chamber and at least one vortex port in said bottom end of said chamber,
where each of said at least one vortex ports is angled openings in the bottom of said chamber adapted to create a uniform vortex of fluid flowing upward in said chamber.

2. The metal separator device of claim 1 whereby, when material is introduced into the interior of said chamber through said material inlet thus creating a bed of material, fluid being pumped into said fluid inlet into the bottom of said chamber and through each of said vortex ports creates a vortex of fluid flowing from the bottom end of said chamber up the interior of said chamber and out of said exit thereby fluidizing the bed and moving the materials with a higher specific gravity to the bottom of the chamber and materials with a lower specific gravity to the top of the chamber and out of the exit.

3. The metal separator device of claim 1 wherein said fluid inlet includes a plurality of said vortex ports.

4. The metal separator device of claim 3 wherein said plurality of vortex ports is equally spaced around the bottom of said chamber.

5. The metal separator device of claim 1 wherein each of said vortex ports are cut into said chamber at an angle between 10 and 80 degrees.

6. The metal separator device of claim 5 wherein said angle of said vortex ports being approximately 45 degrees.

7. The metal separator device of claim 1 further includes a screen or plurality of screens to cover said vortex ports thereby preventing any material from exiting said chamber through said vortex ports.

8. The metal separator device of claim 1 wherein the bottom end of said chamber includes a bottom cap adapted to seal the bottom end of said chamber,
said bottom cap houses said fluid inlet and provides a cavity between said fluid inlet and said vortex ports.

9. The metal separator device of claim 8 wherein said bottom cap comprises:
a top section sealed to said chamber above said vortex ports; and
a bottom section that includes an inlet port for introducing fluid and, which is adapted to be sealed to said top section thereby creating said cavity between said top section and said bottom section.

10. The metal separator device of claim 1 further comprises at least one flow disturbance device positioned on the interior of said chamber.

11. The metal separator device of claim 1 wherein said material inlet is selectively sized to allow material up to a selected inlet size into the interior of said chamber.

12. The metal separator device of claim 11 wherein said material inlet includes a funnel adapted for introducing material into said chamber, said funnel includes a bottom opening sized to said selected inlet size.

13. The metal separator device of claim 12 wherein said bottom opening of said funnel is below said exit and thus positioned in said vortex of fluid, whereby material introduced into said chamber through said material inlet is submerged into said vortex of fluid.

14. The metal separator of claim 1 wherein said exit includes a channel selectively sized to allow material up to a selected exit size to exit said chamber,
said bottom opening of said funnel and the interior of said chamber creates said channel.

15. The metal separator device of claim 1 wherein the top end of said chamber includes a sleeve sealed to the top of said chamber, said sleeve includes said exit on its side and an opening at its top sized to receive said funnel.

16. A system for metal separation comprises a plurality of metal separator devices linked to one another where the first metal separator device separates a first sized material and each subsequent metal separator device separates a smaller sized material,
each of said metal separator devices comprises:
a chamber with a top end and a bottom end;
said chamber has a constant size throughout its length from said bottom end to said top end;
said top end includes:
a material inlet in communication with the interior of said chamber;
an exit to allow fluid and material to exit the top end of said chamber; and
said exit is positioned above said material inlet; and
said bottom end includes:
a fluid inlet in communication with at least one vortex port in said chamber, where each of said at least one vortex ports is an angled opening in the bottom of said chamber adapted to create a vortex of fluid flowing upward in said chamber.

17. The system for metal separation of claim 16 wherein the exit of each of said metal separator devices is in fluid communication with the material inlet of a subsequent metal separator device via a connector conduit.

18. The system for metal separation of claim 17 wherein each of said connector conduits includes:
a selectively sized grate to allow material up to a certain size to move into the material inlet of a subsequent metal separator device;
an internal funnel between said selectively sized grate and the material inlet;
a withdrawal tube for moving material to large to pass through said selectively sized grate out of said system; and
each of said withdrawal tubes is linked together to subsequent withdrawal tubes.

19. A method of separating metals comprising the steps of:
providing a metal separator device, said metal separator device comprises:
a chamber with a top end and a bottom end;
said chamber has a constant size throughout its length from said bottom end to said top end;
said top end includes:
a material inlet in communication with the interior of said chamber;
an exit to allow fluid and material to exit the top end of said chamber; and
said exit is positioned above said material inlet;
said bottom end includes:
a fluid inlet in communication with at least one vortex port in said chamber, where each of said at least one vortex ports is an angled opening in the bottom of said chamber adapted for creating a vortex of fluid flowing upward in said chamber;
inserting material into said material inlet thereby creating a bed of material in the interior of said chamber;
pumping a fluid into said fluid inlet through each of said vortex ports into the inside of said chamber creating a vortex of fluid flowing from said fluid inlet up through said chamber and out of said exit thereby fluidizing the bed of material and moving the materials with a higher specific gravity to the bottom of the chamber and materials with a lower specific gravity to the top of the chamber and out of the exit.

20. The method of separating metals of claim 19 further comprising the steps of:
providing at least one subsequent metal separator device;
connecting said exit of said metal separator device with the material inlet of said subsequent metal separator device via a connector conduit;
providing a selectively sized grate in said connector conduit between said exit and said material inlet;
moving material smaller than said selectively sized grate into the chamber of said subsequent metal separator device; and
removing material larger than said selectively sized grate via a withdrawal tube.
